(19) United States
(12) Patent Application Publication
(10) Pub. No.: US 2013/0128310 A1
(43) Pub. Date: May 23, 2013

(54) OUTPUT CONTROL APPARATUS, OUTPUT CONTROL SYSTEM, AND OUTPUT CONTROL METHOD

(71) Applicant: Yukiko KAIDA, Setagaya (JP)

(72) Inventor: Yukiko KAIDA, Setagaya (JP)

(21) Appl. No.: 13/680,963

(22) Filed: Nov. 19, 2012

(30) Foreign Application Priority Data
Nov. 18, 2011 (JP) 2011-253176

(51) Int. Cl. G06K 15/02

(52) U.S. Cl. CPC G06K 15/02
USPC 358/1.15

(57) ABSTRACT

An output control apparatus that includes a network interface that connects to an output device, a storing unit that stores a document and output control information indicating whether each page of the document is permitted to be output on the output device, and an output document control unit that determines, when a request for obtaining the stored document is received from the output device, which page images of the document are permitted to be output on the output device based on the output control information and the output device and that sends to the output device each page image which is determined to be permitted to be output on the output device.

### CROSS-REFERENCE TO RELATED APPLICATIONS

The present application claims priority under 35 U.S.C. §119(a) to, and incorporates by reference the entire contents of, Japanese Patent Application No. 2011-253176 filed in Japan on Nov. 18, 2011.

### BACKGROUND

Japanese Patent Application Laid-open No. 2009-042964 describes a conference system which includes a document output function.

In this conference system, when the conference system outputs a document of the conference, the conference system is not permitted to output the document of the conference if the participants of the conference include a person who does not have access to the document.

### SUMMARY

Aspects of this disclosure relate to an output control apparatus, a device, processes, algorithms and systems.

An output control apparatus that includes a network interface that connects to an output device, a storing unit that stores a document and output control information indicating whether each page of the document is permitted to be output on the output device, and an output document control unit that determines, when a request for obtaining the stored document is received from the output device, which page images of the document are permitted to be output on the output device based on the output control information and the output device and that sends to the output device each page image which is determined to be permitted to be output on the output device.

An output control system including an output control apparatus and an output device, the output control system including a storing unit that stores a document and output control information indicating whether each page of the document is permitted to be output on the output device, and an output document control unit that determines, when a request for obtaining the stored document is received from the output device, which page images of the document are permitted to be output on the output device based on the output control information and the output device and that sends to the output device each page image which is determined to be permitted to be output on the output device.

An output control method implemented on an output control apparatus that includes the steps of storing a document and output control information indicating whether each page of the document is permitted to be output on an output device, on the output control apparatus, determining using the microprocessor, when a request for obtaining the stored document is received from the output device, which page images of the document are permitted to be output on the output device based on the output control information and the output device, and sending to the output device each page image which is determined to be permitted to be output on the output device.

The foregoing paragraphs have been provided by way of general introduction, and are not intended to limit the scope of the following claims. The described exemplary implementations, together with further advantages, will be best understood by reference to the following detailed description taken in conjunction with the accompanying drawings, wherein like reference numerals designate identical or corresponding parts throughout the several views.

### BRIEF DESCRIPTION OF THE DRAWINGS

FIG. 1 is a diagram illustrating a system configuration of a document output system;

FIG. 2 is a block diagram of a hardware configuration of an output control server;

FIG. 3 is a diagram illustrating a functional configuration of the output control server;

FIG. 4 is a table indicating output device information;

FIG. 5 is a diagram illustrating a document file, a page image and document information;

FIG. 6 is a display screen for setting output control information;

FIG. 7 is a further table indicating output control information;

FIG. 8 is a sequence diagram illustrating a procedure for a process of document registering;

FIG. 9 is a sequence diagram illustrating a procedure for a process of document output;

FIG. 10 is a diagram indicating output document data;

FIG. 11 is another display screen for setting output control information;

FIG. 12 is a further table indicating output control information;

FIG. 13 is another display screen for setting output control information;

FIG. 14 is a further table indicating output control information;

FIG. 15 is another display screen for setting output control information;

FIGS. 16 A-C are each a further table indicating output control information;

FIG. 17 is a diagram indicating output document data;

FIG. 18 is another display screen for setting output control information;

FIG. 19 is a further table indicating output control information;

FIG. 20 is a diagram indicating permitted period for output document;

FIG. 21 is a diagram indicating output document data;

FIG. 22 is a diagram indicating changed page image; and

FIG. 23 is a diagram indicating output document data.

### DETAILED DESCRIPTION

Hereinafter, exemplary implementations will be described with reference to the accompanying drawings. However, variations and modifications may be made without departing from the basic concepts described herein. As used herein the words “a” and “an” and the like carry the meaning of “one or more.”

In a conventional conference system, the conventional conference system is able to limit access to a document. However, the conventional conference system is unable to individually limit access to each page of the document.

In an output control apparatus according to aspects of the present disclosure, the output control apparatus is able to individually limit access to each page of document.

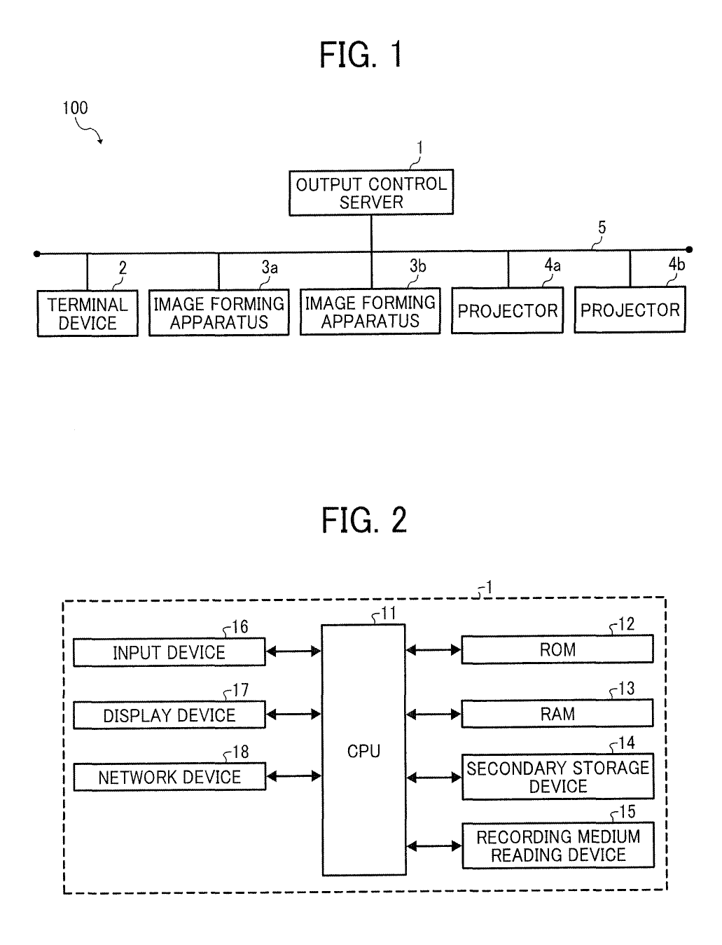

FIG. 1 is a diagram illustrating a system configuration of a document output system 100. The document output system 100 includes an output control server 1, a terminal device 2, an image forming apparatus 3a, an image forming apparatus 3b, a projector 4a, and a projector 4b which are connected via a network 5.

The document output server 1 controls a document to be output. The document output server 1 receives a document from the terminal device 2, and stores the received document. Further, in response to a request for obtaining an output document from an output device which includes, for example, the image forming apparatus 3 or the projector 4, the document output server 1 sends, to the output device, only the particular page images of the output document requested by the output device, based on the output device. In this way, the output device is able to control document output on a page level.

The terminal device 2 is used by a user. For example, the terminal device 2 may be one of a personal computer (PC), a mobile terminal and a tablet computer. The terminal device 2 inputs a document, to be output, to the output control server 1.

The image forming apparatus 3 is an example of the output device, and is a multi function peripheral which includes a copy function, a scanner function, a printer function and a facsimile function. The image forming apparatus 3 receives a document to be output from the output control server 1, and prints page data of the received document on a recording medium.

The projector 4 is an example of the output device, and is an image projection apparatus which projects an image. The projector 4 receives a document to be output from the output control server 1, and projects, on a projection screen, page data of the received document.

The network 5 is a communication network which connects the output control server 1, the terminal device 2, the image forming apparatus 3, and the projector 4. In this description, connections which include a connection between the output control server 1 and the terminal device 2, and a connection between the output control server 1 and the output device such as the image forming apparatus 3 and the projector 4, are realized by network 5.

In this description, the image forming apparatus 3 and the projector 4 are included as examples of the output device, however the output device is not limited by these apparatuses. The output device, for example, may include a PC, a mobile terminal or a tablet computer. In such a case, an output is the displaying on display screen of the mobile terminal or the tablet computer.

FIG. 2 is a block diagram of an exemplary hardware configuration of the output control server 1.

As illustrated in FIG. 2, the output control server 1 includes a central processing unit (CPU) 11, a read only memory (ROM) 12, a random access memory (RAM) 13, a secondary storage device 14, a recording medium reading device 15, an input device 16, a display device 17, and a network device 18.

The CPU 11 may be implemented by a microprocessor and a peripheral circuit, and controls the output control server 1. The ROM 12 is a memory medium to store a control program executed by the CPU 11. The RAM 13 is a memory used by CPU 11 as a working area, when CPU 11 executes the control program stored in the ROM 12.

The secondary storage device 14 is a storage device that stores an operating system and information including a program. For example, the secondary storage device 14 includes a hard disk drive (HDD). The recording medium reading unit 15 is a device that reads information from an external device such as a USB memory and a DVD.

The input device 16 is a device that receives input operations from a user. For example, the input device 16 includes a mouse, a keyboard, a touch panel switch included in the display device. The display device 17 is a device that displays data on a display screen. For example, the display device 17 includes a liquid crystal display (LCD) and a cathode ray tube (CRT).

The network device 18 is a device that communicates with other devices. For example, the network device 18 includes wired network interface and wireless network interface.

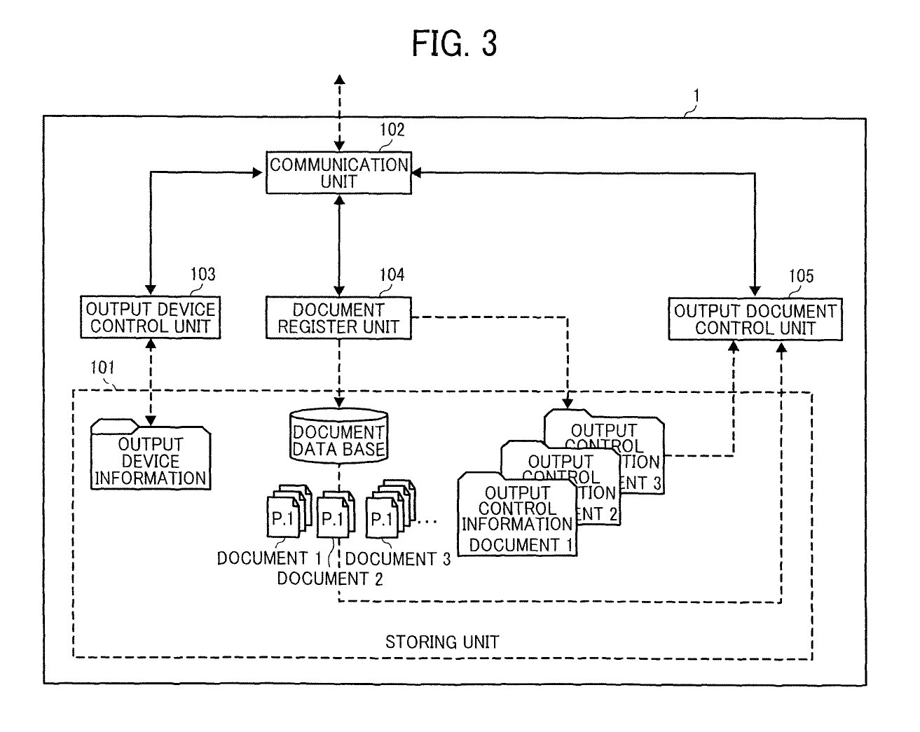

FIG. 3 is a diagram illustrating a functional configuration of the output control server 1. As illustrated in FIG. 3, the output control server 1 includes a storing unit 101, a communication unit 102, an output device control unit 103, a document register unit 104, and an output document control unit 105.

The communication unit 102 executes connection to the terminal device 2 and the output device via the network. The output device control unit 103 controls output device information which is stored in the storing unit 101. The output device information indicates which output devices are available among the output devices.

When each of the output devices is booted, each of the output devices sends, to the output device control unit 103, information indicating that booting has been commenced. In response to receiving this information, the output device control unit 103 adds the output device, which sent the information, to the output device information as an available output device.

When each of the output devices is shut down, each of the output devices sends, to the output device control unit 103, information indicating that shutdown has been commenced. In response to receiving this information, the output device control unit 103 deletes an output device, which sent the information, from the output device information. In this way, the output device control unit 103 controls the output device information by dynamically updating the output device information.

The document register unit 104, in response to receiving a request for registering a document from the terminal device 2, registers a document in a document database of the storing unit, based on the request. Further, the document register unit 104 generates page image data based on the document. Further, the document register unit 104 separately registers the document as an original document and the generated page images. Further, the original document and the generated page images are registered in association with each other.

The document register unit 104 obtains information indicating whether the output device is able to output each page of the document. Further, the document register unit 104 generates output control information regarding the document based on the obtained information, and registers the generated output control information. In detail, the document register unit 104 may receive information indicating that a particular output device is not permitted to output a particular page of the document. Further, the document register unit 104 is able to generate the output control information based on this received information.

The output document control unit 105, in response to receiving a request for obtaining a document stored in the output control server 1 from one of output devices, which are available, refers to the output control information stored in the storing unit 101. Based on the output control information, the output document control unit 105 sends a page image of the requested document. In detail, the output document control unit 105 sends, to the output device which sent the request, the page image when the requested page image is permitted to be output on the requesting output device.

The storing unit 101 stores the output device information, documents, and the output control information. The above described functional units may be realized by programs executed by CPU 11.

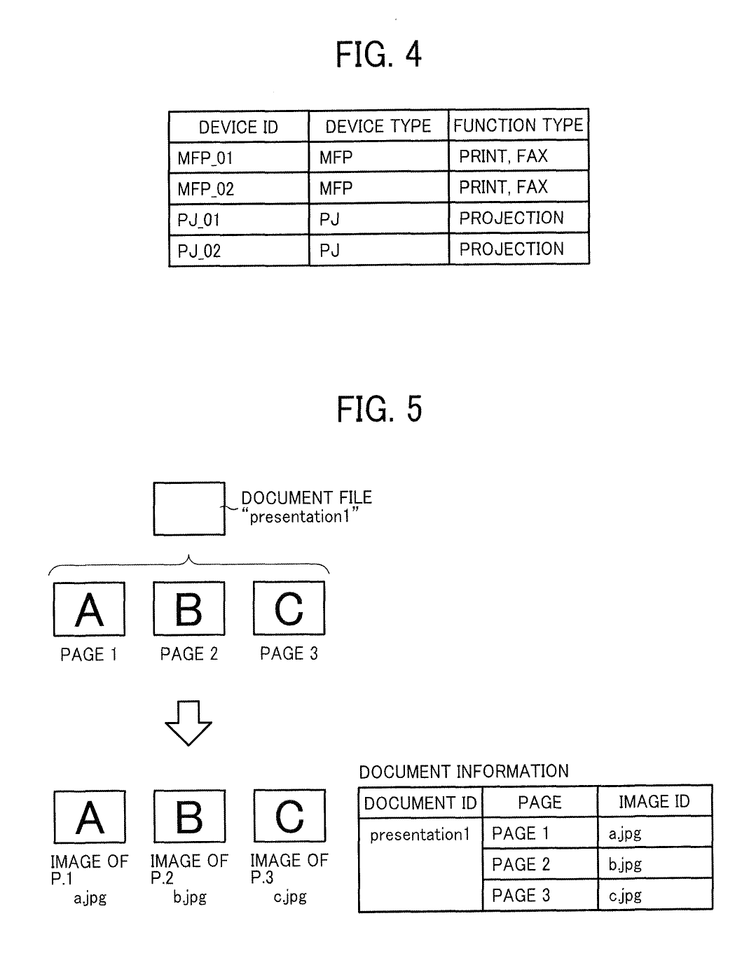

FIG. 4 is a table indicating the output device information. As illustrated in FIG. 4, the output device information has contents including device ID, device type and function type.

The device ID is identification information that identifies an output device. The device type indicates the kind of the output device. For example, an entry of “MFP” indicates that the output device is an image forming apparatus, and an entry of “PJ” indicates that the output device is a projector.

The function type indicates which function is provided by the output device.

As described above, the output device control unit 103 controls information, indicating which apparatus are available, as the output device information. Further, the output device control unit 103 is able to generate the contents of the output device information based on the messages sent from each of the apparatuses.

In this embodiment, the device ID of the image forming apparatus 3a is MFP_01 and the device ID of the image forming apparatus 3b is MFP_02. Further, the device ID of the projector 4a is PJ_01 and the device ID of the image forming apparatus 4b is PJ_02.

FIG. 5 is a diagram illustrating a document file, a page image and document information.

As described above, the document register unit 104 generates page image data of a document, when the document register unit 104 registers the document. As illustrated in FIG. 5, the document register unit 104 generates, from a document file of presentation 1, three page images including a.jpg, b.jpg, and c.jpg.

The document register unit 104 registers the generated page images associated with the document file of presentation 1. Further, the document file and the registered page images are entered as document information into the document data-base. In detail, a.jpg is corresponded to a page 1 of the document file, b.jpg is corresponded to a page 2 of the document file, and c.jpg is corresponded to a page 3 of the document file.

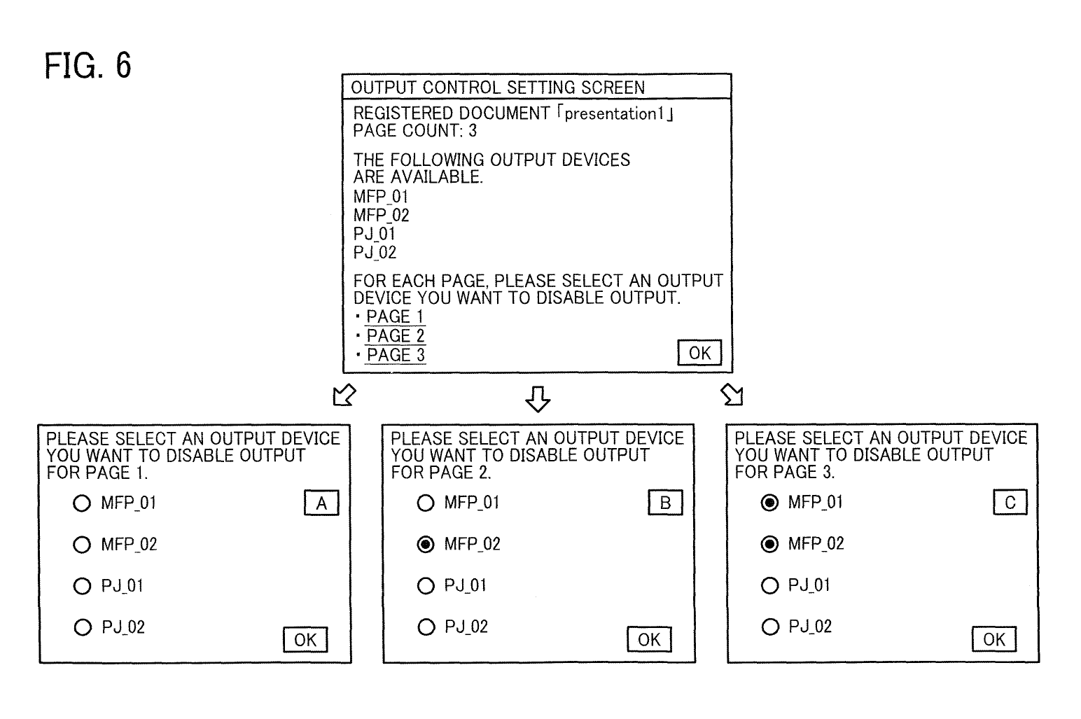

FIG. 6 is a display screen for setting output control information. As described above, the document register unit 104 obtains information indicating whether the output device is permitted to output each page of the document, and the document register unit 104 generates output control information regarding the document, based on the obtained information. In detail, the document register unit 104 displays a display screen, by which the output control information may be set, on the terminal device 2.

When the document file of presentation 1 is registered on the output control server 1 from the terminal device 2, the output control server 1 sends the display screen, for setting the output control information, to the terminal device 2. Further, the terminal device 2 displays the display screen sent from the output control server on the terminal device 2.

As illustrated in FIG. 6, the display screen for setting output control information displays information indicating that the document file of presentation 1 is constructed by 3 pages and device information indicating which output devices are available.

A user is able to select a device that is not permitted to output the document file. For example, MFP_02 is selected as a device that is not permitted to output page 2 of the document file, and MFP_01 and MFP_02 are selected as devices that are not permitted to output page 3 of the document file. Further, the display screen is able to include a thumbnail image of each page image.

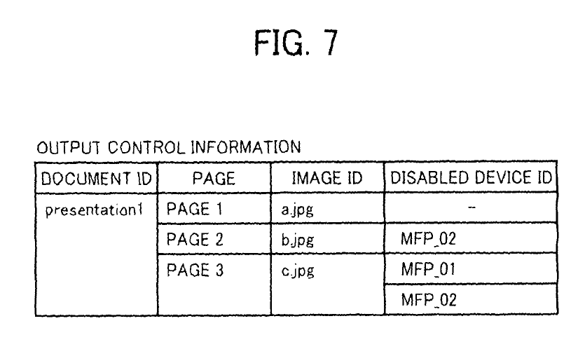

FIG. 7 is a table indicating the output control information.

As illustrated in FIG. 7, the output control information is generated for the registered document of presentation 1. MFP_02 is set as a disabled device ID indicating that page 2 of the document file should not be output to this device. Further, MFP_01 and MFP_02 are each set as a disabled device ID indicating that page 3 of the document file should not be output to these devices.

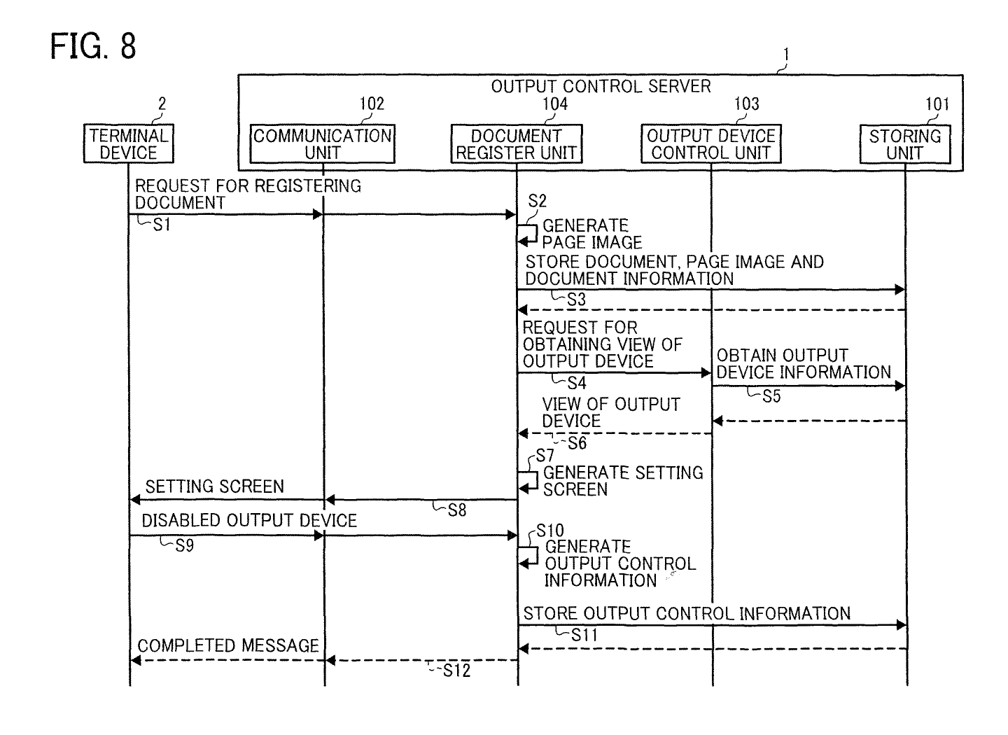

FIG. 8 is a sequence diagram illustrating a procedure for a process of document registration.

As illustrated in FIG. 8, the terminal device 2 sends, to the output control server 1, a request for registering a document together with the document file (step: S1). Herein, the document is referred to as the output document to be output on the output device.

Next, when the document register unit 104 of the output control server 1 receives the request for registering the document sent from the terminal device 2 via the communication unit 102, the document register unit 104 generates page image(s) of the received document in accordance with a predetermined data format (step: S2). For example, the predetermined data format may be the JPEG format.

Next, the register unit 104 stores the received document and the generated page image(s) in the storing unit 101 (step: S3). Next, the register unit 104 sends a request for obtaining a list of output devices to the output device control unit 103 (step: S4).

Next, when the output device control unit 103 receives the request for obtaining a list of output devices, the output device control unit 103 obtains output device information from the storing unit 101 (step: S5). The output device information includes information indicating which output devices are available.

Next, the output device control unit 103 sends the list of output devices to the document register unit 104 by referring to the obtained output device information (step: S6). For example, if the information indicates that MFP_01, MFP_02, PJ_01 and PJ_02 are available, a list including these devices is sent to the document register unit 104. Next, when the document register unit 104 receives the list of output devices sent from the output device control unit 103, the document register unit 104 generates a setting screen to obtain the output control information (step: S7).

Next, the document register unit 104 sends the generated setting screen to the terminal device 2 (step: S8). The terminal device 2 displays the setting screen sent from the document register unit 104. Next, the terminal device 2 sends, to the document register unit 104, information indicating which devices should be prohibited from outputting each page of document in accordance with user operation (step: S9).

Next, when the document register unit 104 receives the information sent from the terminal device 2, the document register unit 104 generates output control information for the document (step: S10). Next, the document register unit 104 stores the generated output control information in the storing unit 101 (step: S11). The generated output control information is used when document is output by the output device.

Next, the document register unit 104 sends a message indicating that the registration of the document is completed (step: S12).

Furthermore, it is possible that a particular output device may be selected to output a particular page. Further, the output control server 1 is able to locally receive settings on the output control server 1. In this case, process of S1, S8, and S9 are executed on the output control server 1.

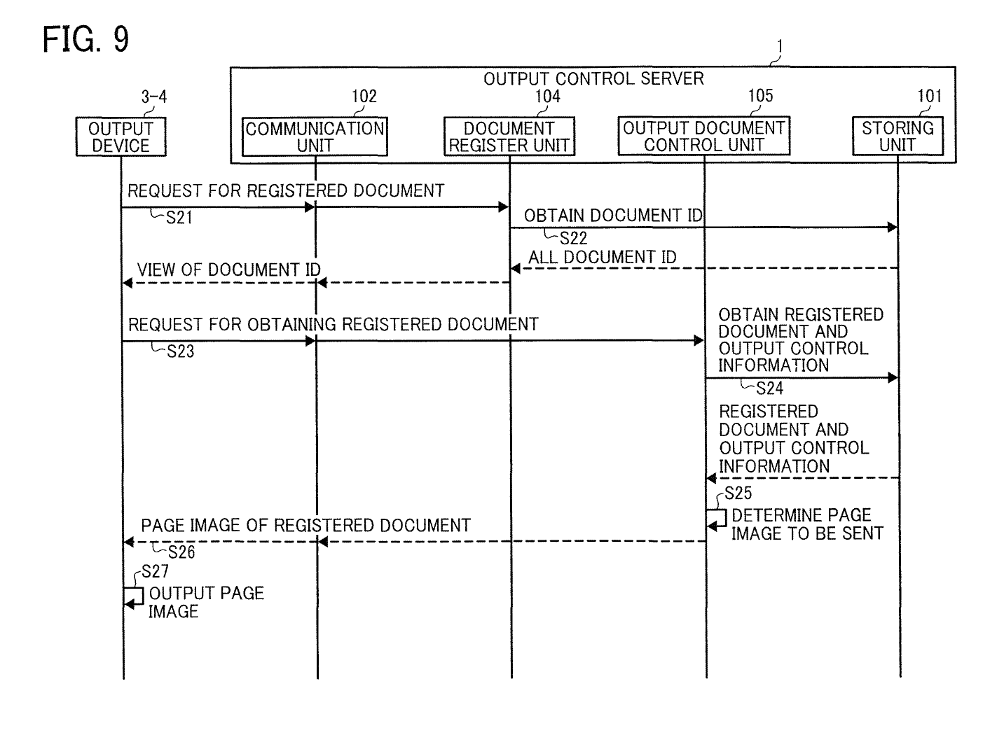

FIG. 9 is a sequence diagram illustrating a procedure for a process of document output.

As illustrated in FIG. 9, the output device sends a request for a registered document to the output control server 1 (step: S21). Next, when the document register unit 104 receives the request sent from the output device, the document register unit 104 obtains, from the storing unit 101, all document IDs stored in the storing unit 101 (step: S22). Further, the document register unit 104 sends a list of the document IDs, created based on the obtained document IDs, to the output device.

Next, when the output device receives the list of document IDs sent from the document register unit 104, the output device displays the received list of document IDs. Further, when the output device receives a designation of one document among documents of the list, the output device sends a request for obtaining the designated document to the output control server 1 (step: S23). The request includes the document ID which identifies the document and the device ID of the output device.

Here, when the output device is the image forming apparatus 3, the image forming apparatus 3 displays the list of document IDs on the operation panel. Further, when the output device is the projector 4, the projector 4 projects the list of document IDs on a projection surface.

Next, when the output document control unit 105 receives the request for obtaining the designated document sent from the output device, the output document control unit 105 obtains, from the storing unit 101, the requested document and the output control information for the requested document (step: S24). Next, the output document control unit 105 determines the page images to be sent to the output device by referring the output control information (step: S25). In detail, the output document control unit 105 determines whether the device ID which was sent from the output device is registered in the output control information. Further, the output document control unit 105 determines whether any of the pages are registered such that output is prohibited for the device ID. When such a prohibition is found, the output document control unit 105 determines that the page is not available for output to the output device.

Next, the output document control unit 105 sends, to the output device, the permitted page image(s) via the communication unit 102 (step: S26). Next, the output device outputs the received page image(s) (step: S27).

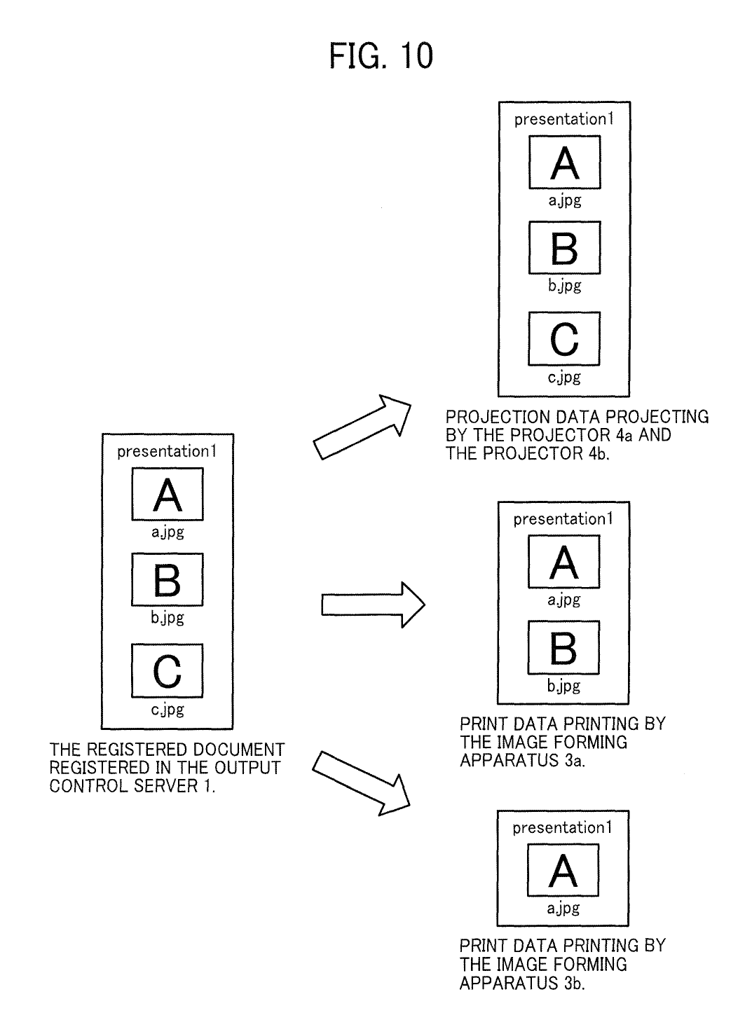

FIG. 10 is a diagram indicating output document data.

As illustrated in FIG. 10 the projector 4a and the projector 4b are permitted to output all pages of the registered document of presentation 1 based on the output control information of FIG. 7. However, image forming apparatus 3a is only permitted to output page 1 and page 2 among the total 3 pages while image forming apparatus 3b is only permitted to output page 1 among the total 3 pages.

In this way, when output device outputs document, the document control server sends only the allowed page image(s) to the output device based on the output device. Thus, the document output system is able to control the outputting of the document by page unit.

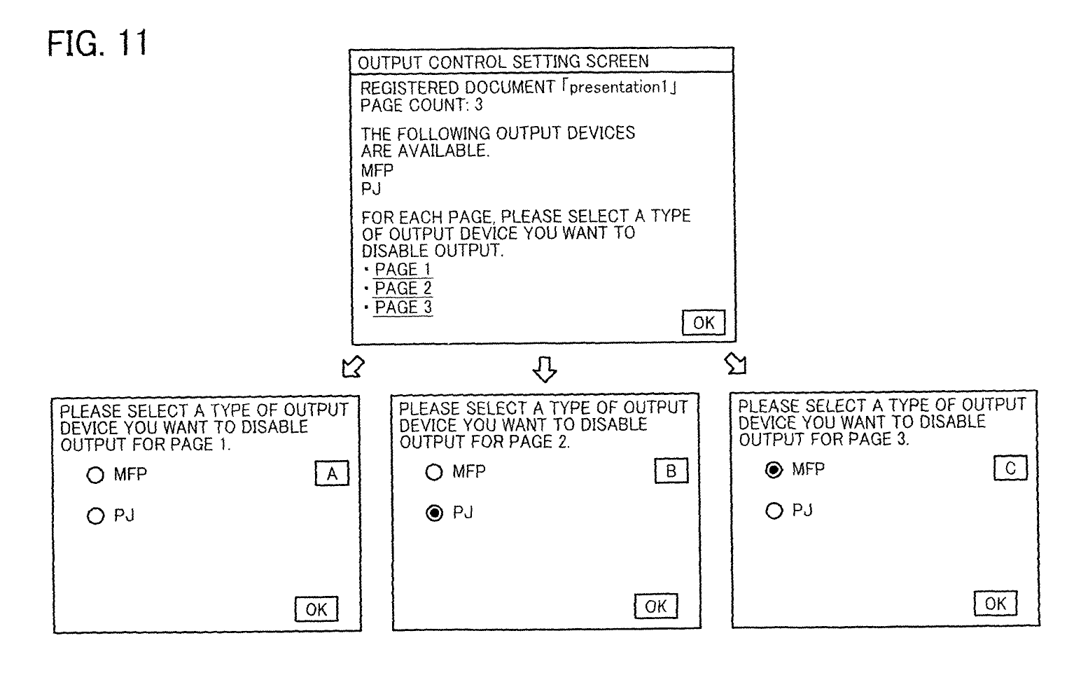

FIG. 11 is another example of a display screen for setting output control information. By this description, the type of output device which is not permitted to output the document is able to be set.

When the document control server 1 registers the document file of presentation 1 by receiving the document file from the terminal device 2, the document control server 1 sends the setting display for the output control information to the terminal device 2. Further, information indicating that the registered document of presentation 1 is constructed by 3 pages and information indicating the particular type(s) of the output device(s) which are available, are displayed. As illustrated in FIG. 11, PJ is selected with respect to page 2, and MFP is selected with respect to page 3.

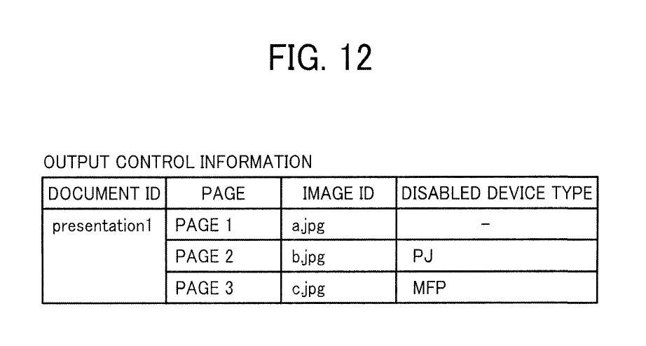

FIG. 12 is another example of a table indicating output control information.

As illustrated in FIG. 12, the output control information includes disabled device type field. Further, the output control information is generated based on the above described setting process.

Based on the output control information of FIG. 12, the projector 4a and the projector 4b are permitted to output only page 1 and page 3 among the total 3 pages of the registered document of presentation 1. Further, the image forming apparatuses 3a and 3b are permitted to output only page 1 and page 2 among the total 3 pages.

Here, the document output server is able to determine the type of the output device based on the device ID. Thus, when the document output server receives a request for a registered document sent from an output device, the document output server is able to determine the type of the output device by obtaining the device ID of the output device and referring to the output device information.

In this way, the document output system is able to control the outputting of the document by page unit and based on output device type.

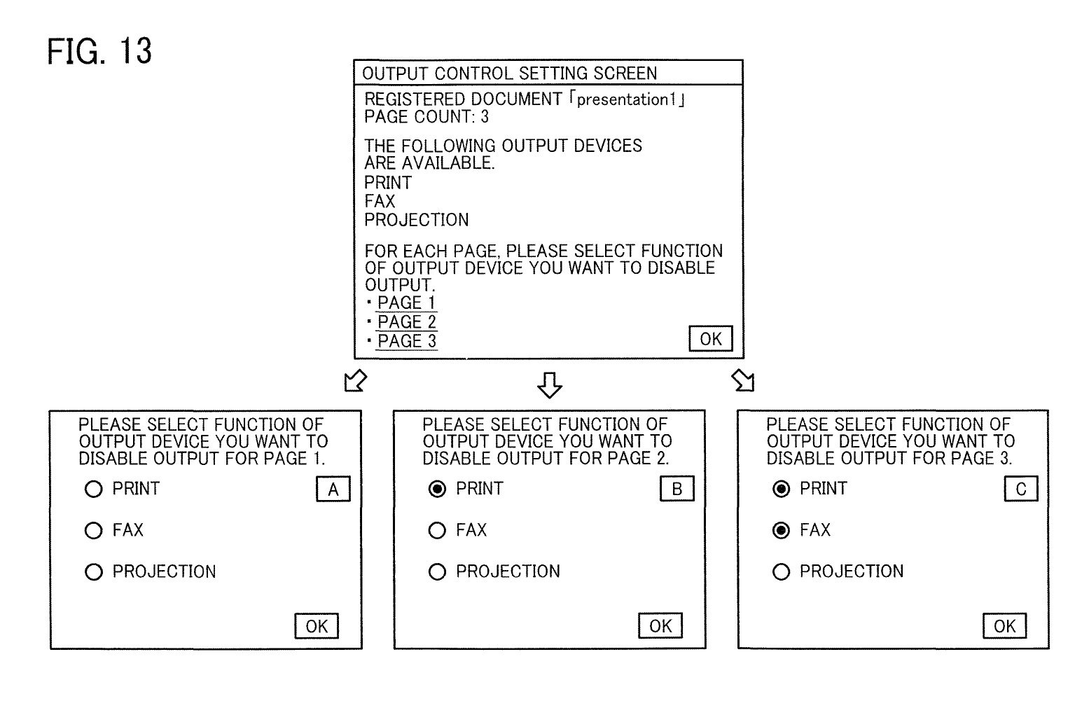

FIG. 13 is another example of a display screen for setting output control information. By this description, the type of function which is not permitted to output the document is able to be set.

When the document control server 1 registers the document file of presentation 1 by receiving the document file from the terminal device 2, the document control server 1 sends the setting display for the output control information to the terminal device 2. Further, information indicating that the registered document of presentation 1 is constructed by 3 pages and information indicating the particular type(s) of function which are available to selected as disabled, are displayed. As illustrated in FIG. 13, PRINT is selected with regard to page 2 and PRINT and FAX are selected with regard to page 3.

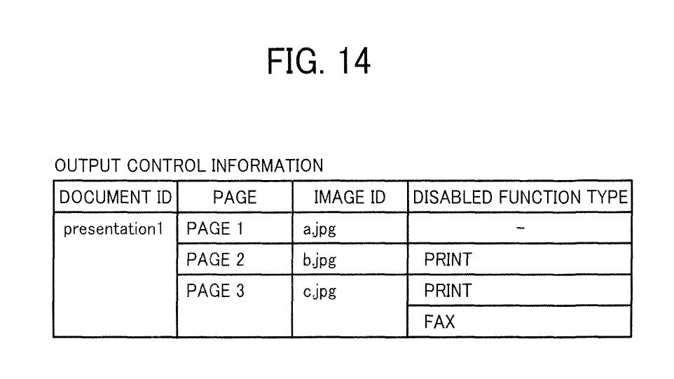

FIG. 14 is another example of a table indicating output control information.

As illustrated in FIG. 14, the output control information includes disabled function type field. Further, the output control information is generated based on the above setting process.

Based on the output control information of FIG. 14, the projector 4a and the projector 4b are permitted to output all pages among the total 3 pages of the registered document of presentation 1. Further, the image forming apparatuses 3a and 3b, which include print function and fax function, are permitted to output only page 1 and page 2 among the total 3 pages (with page 2 only being available for output via fax).

Here, the document output server is able to determine the type of function of the output device based on the device ID. Thus, when the document output server receives a request for a registered document sent from an output device, the document output server further receives the type of function of the output device.

In this way, the document output system is able to control the outputting of the document by page unit and based on the function of the output device.

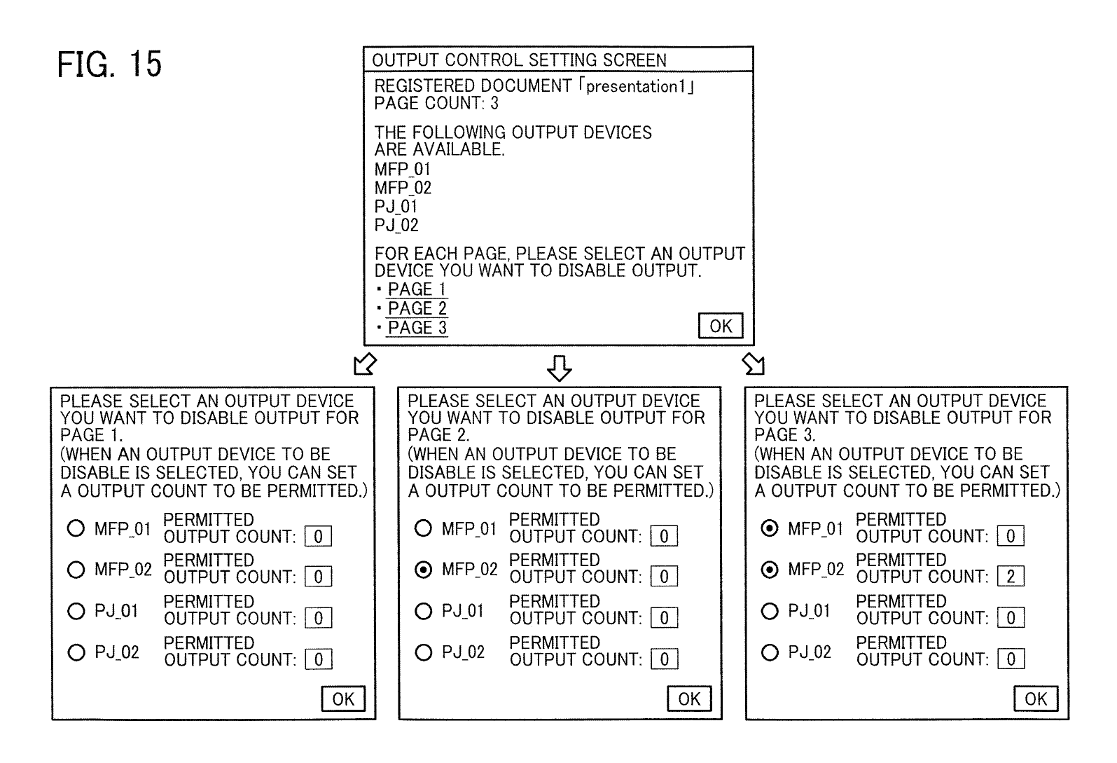

FIG. 15 is another example of a display screen for setting output control information. By this description, the output device which is not permitted to output the document and the permitted output count, which indicates the limit on the number of times the document may be output, are able to be set.

When the document control server 1 registers the document file of presentation 1 by receiving the document file from the terminal device 2, the document control server 1 sends the setting display for the output control information to the terminal device 2. Further, information indicating that the registered document of presentation 1 is constructed by 3 pages and information indicating which device(s) are available, are displayed. Further, a user is able to set the permitted output count which indicates the limit on the number of times the document may be output.

As illustrated in FIG. 15, with regard to page 2, MFP_02 is selected and the permitted output count is set to 0. With regard to page 3, MFP_01 and MFP_02 are selected, and the permitted output count of MFP_01 is set to 0 while the permitted output count of MFP_02 is set to 2.

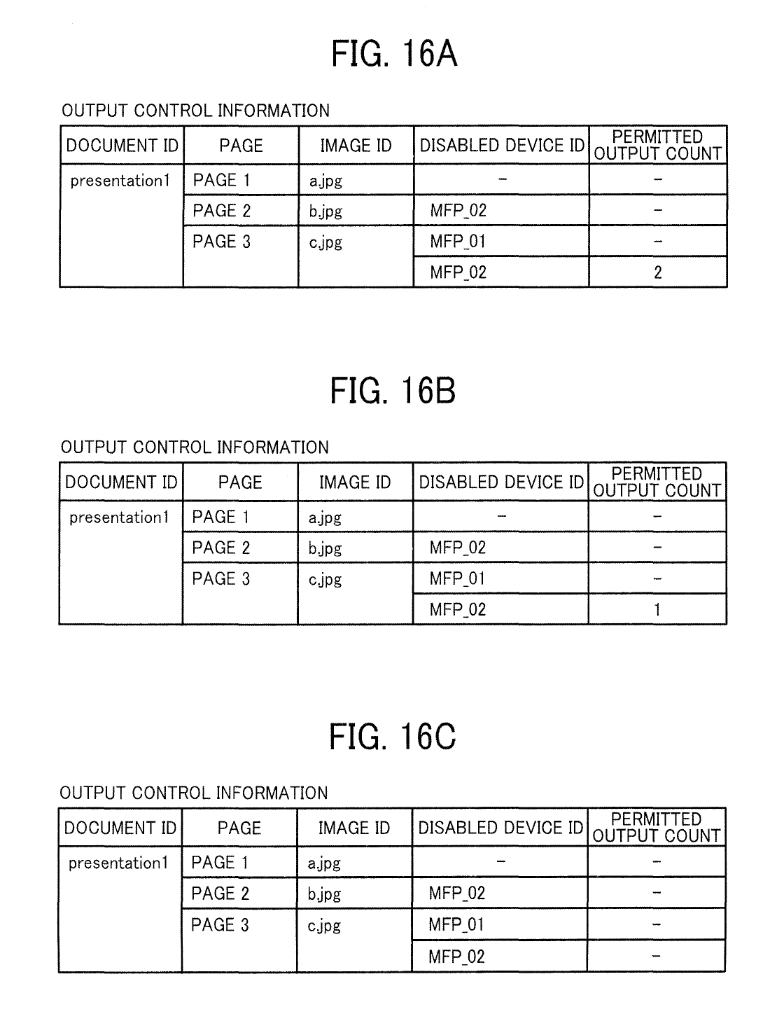

FIG. 16A, FIG. 16B and FIG. 16C are another example of a table indicating output control information.

As illustrated in FIG. 16A, FIG. 16B and FIG. 16C, the output control information includes a permitted output count field. Further, the output control information is generated based on the above setting process.

Based on the output control information of FIG. 16A, the projector 4a and the projector 4b are permitted to output all pages among the total 3 pages of the registered document of presentation 1. Further, the image forming apparatus 3a is permitted to output page 1 and page 2 among the total 3 pages. Further, the image forming apparatus 3b is permitted to output page 1 and page 3 among the total 3 pages.

Further, the output document control unit 105 updates the output control information by subtracting from the permitted output count. FIG. 16B indicates the updated output control information from the output control information of FIG. 16A.

Based on the output control information of FIG. 16B, the projector 4a and the projector 4b are permitted to output all pages among the total 3 pages of the registered document of presentation 1. Further, the image forming apparatus 3a is permitted to output page 1 and page 2 among the total 3 pages. Further, the image forming apparatus 3b is permitted to output page 1 and page 3 among the total 3 pages. Further, the output document control unit 105 updates the output control information by subtracting from the permitted output count. FIG. 16C indicates the updated output control information from the output control information of FIG. 16B.

Based on the output control information of FIG. 16C, the projector 4a and the projector 4b are permitted to output all pages among the total 3 pages of the registered document of presentation 1. Further, the image forming apparatus 3a is permitted to output page 1 and page 2 among the total 3 pages. Further, the image forming apparatus 3b is permitted to output page 1 among the total 3 pages. Here, the output document control unit 105 determines that the image forming apparatus 3b is not permitted to output page 3, because the permitted output count is currently at zero.

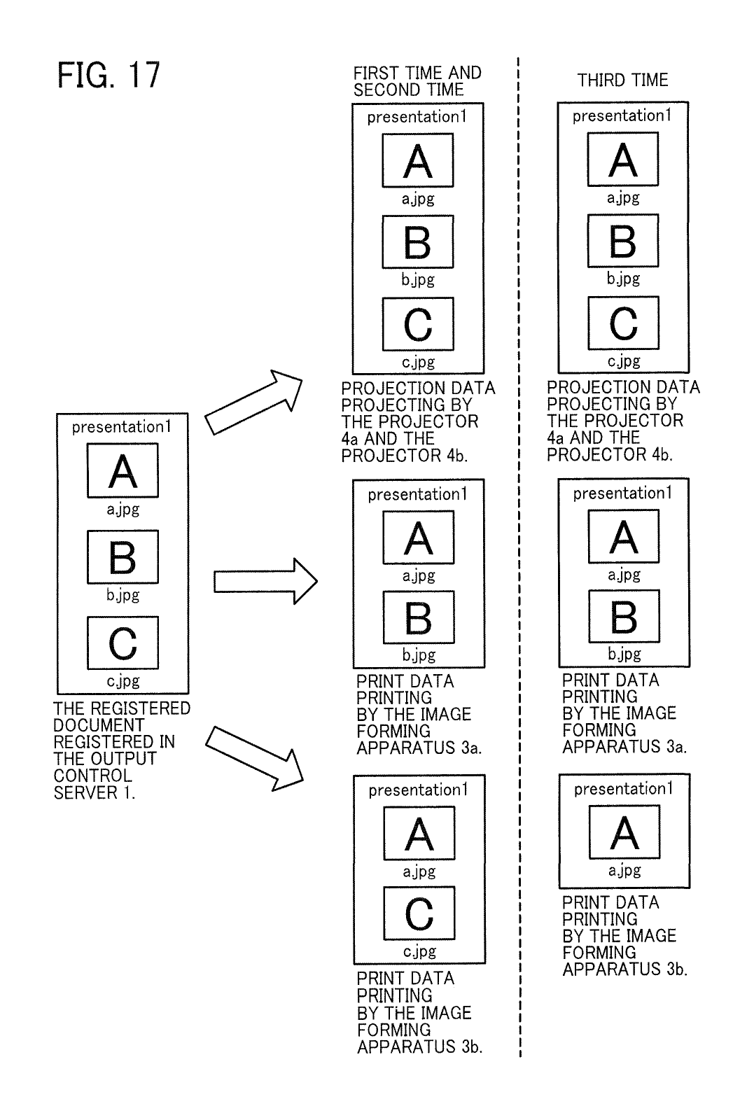

FIG. 17 is another example of a diagram indicating output document data.

As illustrated in FIG. 17, based on the output control information of FIG. 6A, FIG. 6B and FIG. 6C, the projector 4a and the projector 4b are permitted to output all pages of the registered document of presentation 1. Further, the image forming apparatus 3a is permitted to output page 1 and page 2 among the total 3 pages. Further, the image forming apparatus 3b is permitted to output page 1 and page 2 among the total 3 pages no more than 2 times. Thereafter, the image forming apparatus 3b is permitted to output only page 1 among the total 3 pages.

In this way, the document output system is able to control outputting of the document by device unit and designation count.

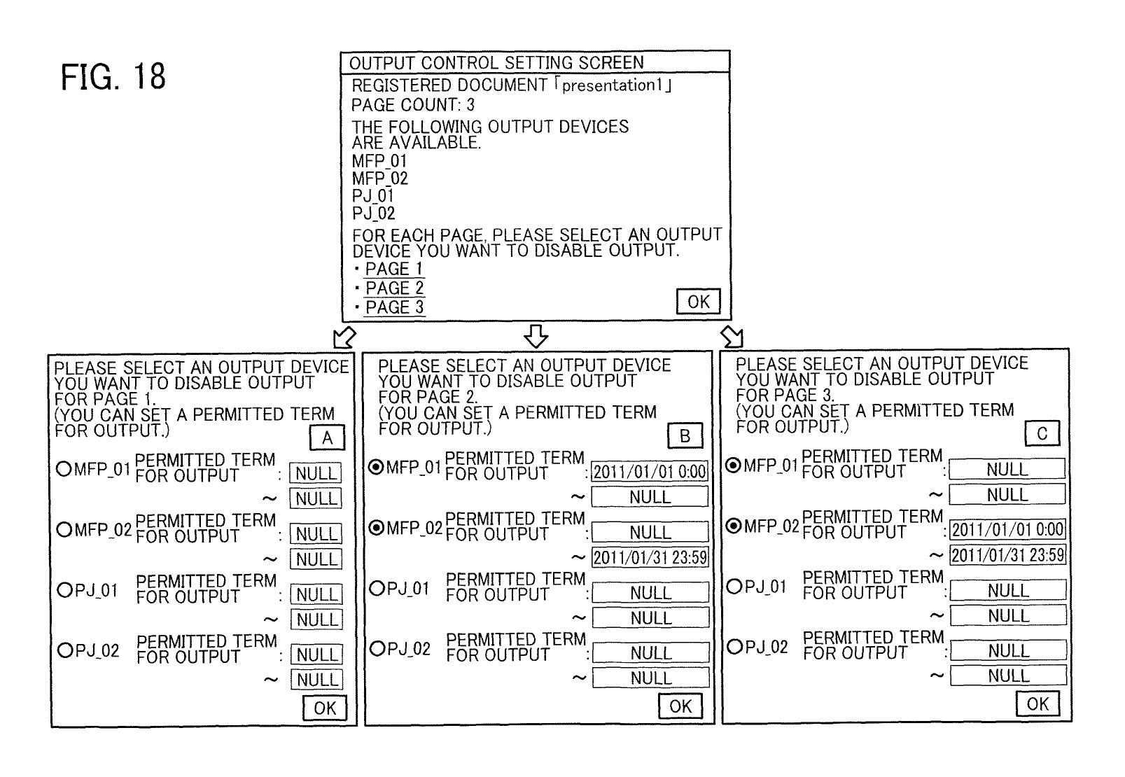

FIG. 18 is another example of a display screen for setting output control information. By this description, the output device which is not permitted to output the document and the permitted term, which provides a term limit on output, are able to be set.

When the document control server 1 registers the document file of presentation 1 by receiving the document file from the terminal device 2, the document control server 1 sends the setting display for the output control information to the terminal device 2. Further, information indicating that the registered document of presentation 1 is constructed by 3 pages and information indicating the particular type(s) of function which are available, are displayed. Further, a user is able to set the permitted term which indicates term limit on output.

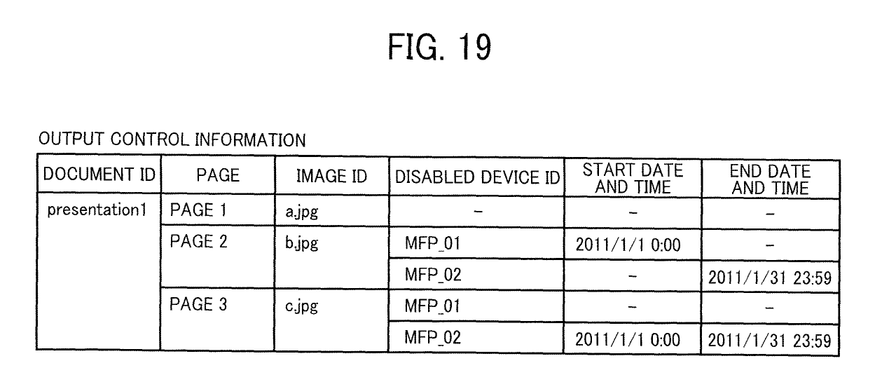

As illustrated in FIG. 18, with regard to page 2, MFP_01 is selected and the permitted term is set from “2011/01/01 0:00” to “NULL”. Further, MFP_02 is selected and the permitted term is set from “NULL” to “2011/01/31 23:59”. With regard to page 3, MFP_01 is selected and the permitted term is set from “NULL” to “NULL”. Further, MFP 02 is selected and the permitted term is set from “2011/01/01 0:00” to “2011/01/31 23:59”. FIG. 19 is another example of a table indicating output control information.

As illustrated in FIG. 19, the output control information includes a start date and time, and an end date and time. Further, the output control information is generated based on the above settings.

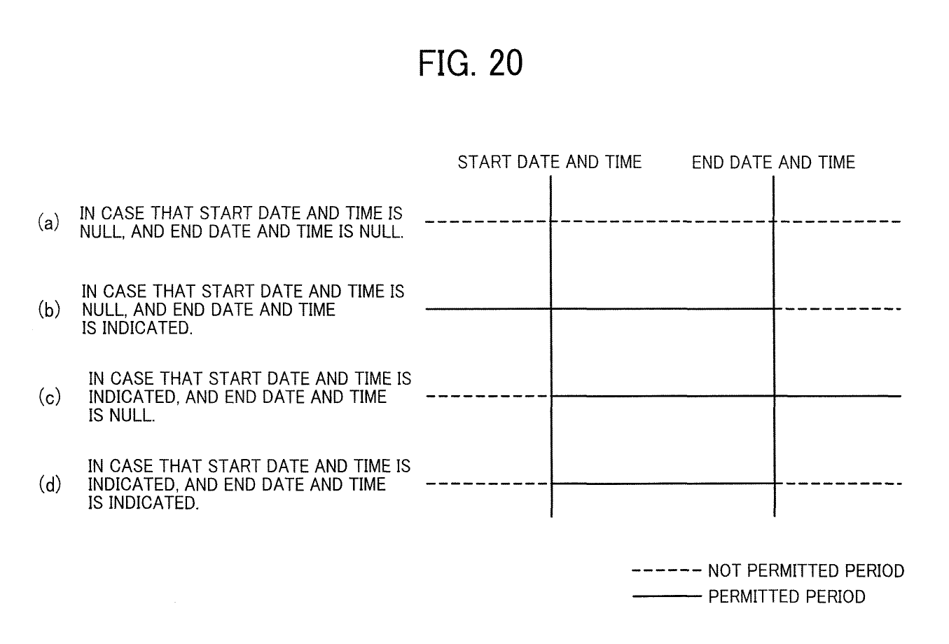

FIG. 20 is a diagram indicating the permitted period for outputting the document.

By way of the setting screen of FIG. 18, the start date and time and the end date and time for which output is permitted are able to be set by user. Case A is an example in which the start date and time are each set to “NULL”, and the end date and time are each set to “NULL”. Further, case B is an example in which the start date and time are each set to “NULL”, while the end date and time are indicated. Further, case C is an example in which the start date and time are indicated while the end date and time are each set to “NULL”. Further, case d is an example in which both the start date and time and the end date and time are indicated.

When the permitted term is set as in case A, the page image is not permitted to be output during any period. Further, when the permitted term is set as in case B, the page image is permitted to be output up until the end date and time. Further, when the permitted term is set as in case C, the page image is permitted to be output only after the start date and time. Further, when the permitted term is set as in case D, the page image is permitted to be output only between the start date and time and the end date and time.

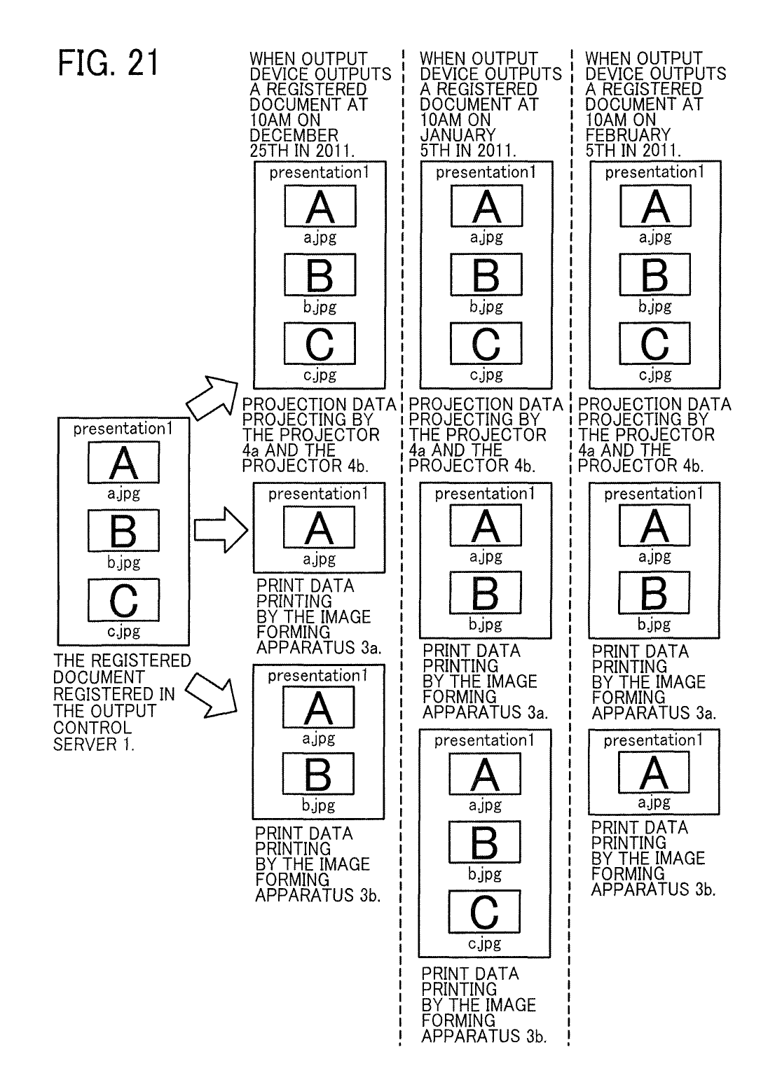

FIG. 21 is another example of a diagram indicating output document data.

As illustrated in FIG. 21, based on the output control information of FIG. 19, the projector 4a and the projector 4b are permitted to output all pages of the registered document of presentation 1 regardless of the current date and time. Further, the image forming apparatus 3a is permitted to only output page 1 when the current date and time is before 12 am on January 1st in 2011. Further, the image forming apparatus 3a is permitted to output both page 1 and page 2 when the current date and time is after 12 am on January 1st in 2011.

Further, the image forming apparatus 3b is permitted to output page 1 and page 2 when the current date and time is before 12 am on January 1st in 2011. Further, the image forming apparatus 3b is permitted to output page 1, page 2, and page 3 when the current date and time is after 12 am on January 1st in 2011 and the current date and time is before 11:59 pm on January 31st in 2011. Further, the image forming apparatus 3b is permitted to output page 1 when the current date and time is after 11:59 pm on January 31st in 2011.

Another example will be described below. In this example, the output document control unit 105 replaces the page image with another page image when the requested page image is not permitted to be output. Further, the document control unit 105 sends the replacement page image to the output device which sent the request.

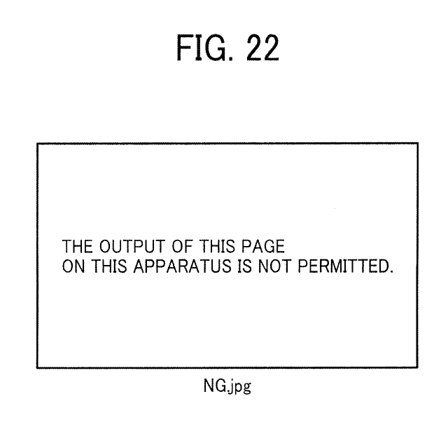

FIG. 22 is an example of a diagram indicating the replacement page image.

As illustrated in FIG. 22, a message “The output of this page on this apparatus in not permitted” is written on the replacement page image. Further, the replacement page image is stored in storing unit 101.

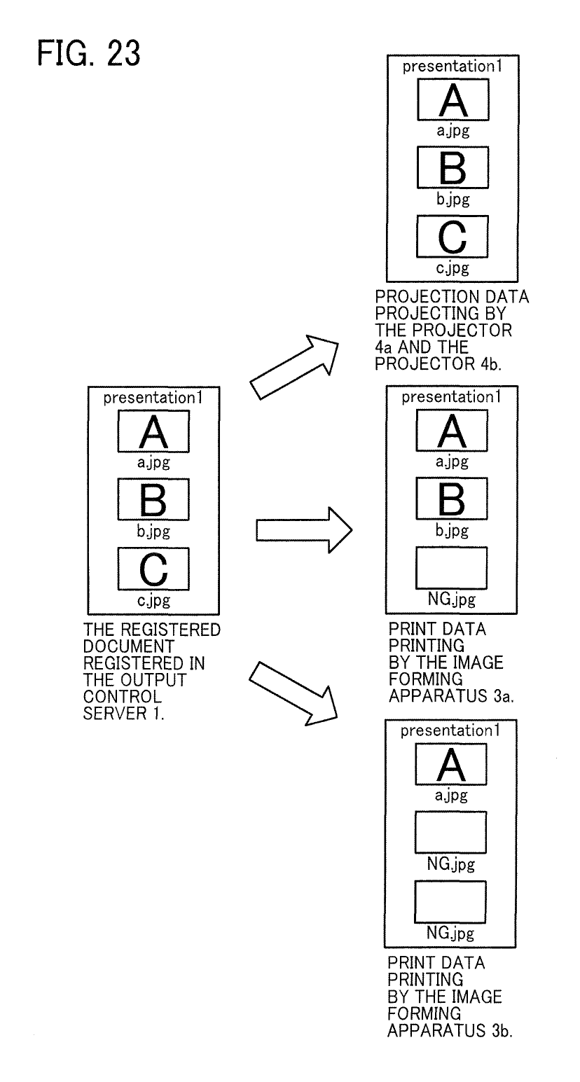

FIG. 23 is an example of a diagram indicating output document data.

As illustrated in FIG. 23, the image forming apparatus 3a outputs page 1, page 2, and replacement page image as page 3. Further, the image forming apparatus 3b outputs page 1 and the replacement page image as both page 2 and page 3.

The descriptions provided herein are only exemplary, and variations and modifications may be made without departing from the concepts discussed herein.

What is claimed is:

1. An output control apparatus, comprising:
a network interface configured to connect to an output device;
a storing unit configured to store a document and output control information indicating whether each page of the document is permitted to be output on the output device; and
an output document control unit configured to determine, when a request for obtaining the stored document is received from the output device, which page images of the document are permitted to be output on the output device based on the output control information and the output device and to send to the output device each page image which is determined to be permitted to be output on the output device.

2. The output control apparatus as claimed in claim 1, wherein the network interface is further configured to connect to an input device, and
the output control apparatus further comprises:
a receiving unit configured to receive the document from the input device.

3. The output control apparatus as claimed in claim 1, wherein the storing unit is further configured to store replacement page image data, and
the output document control unit sends, to the output device, the replacement page image data in place of the page image which is not permitted to be output on the output device.

4. An output control system including an output control apparatus and an output device, the output control system comprising:
a storing unit configured to store a document and output control information indicating whether each page of the document is permitted to be output on the output device; and
an output document control unit configured to determine, when a request for obtaining the stored document is received from the output device, which page images of the document tare permitted to be output on the output device based on the output control information and the output device and to send to the output device each page image which is determined to be permitted to be output on the output device.

5. The output control system as claimed in claim 4,
wherein the output control apparatus includes a network interface configured to connect to the output device and to an input device, and
the output control apparatus further includes a receiving unit configured to receive the document from the input device.

6. The output control system as claimed in claim 4,
wherein the storing unit is further configured to store replacement page image data, and
the output document control unit sends, to the output device, the replacement page image data in place of the page image which is not permitted to be output on the output device.

7. An output control method implemented on an output control apparatus including a microprocessor, comprising:
storing a document and output control information indicating whether each page of the document is permitted to be output on an output device, on the output control apparatus;
determining using the microprocessor, when a request for obtaining the stored document is received from the output device, which page images of the document are permitted to be output on the output device based on the output control information and the output device; and
sending to the output device each page image which is determined to be permitted to be output on the output device.

8. The output control method as claimed in claim 7, further comprising:
receiving the document from an input device, the output control apparatus including a network interface configured to connect to the output device and to the input device.

9. The output control method as claimed in claim 7, further comprising:
storing replacement page image data, and
sending, to the output device, the replacement page image data in place of the page image which is not permitted to be output on the output device.
